(19) United States
(12) Patent Application Publication
(10) Pub. No.: US 2026/0280446 A1
(43) Pub. Date: Sep. 17, 2026

(54) VOLTAGE CONVERTER ASSEMBLY, ELECTRIC DRIVE SYSTEM, AND METHOD FOR OPERATING A VOLTAGE CONVERTER ASSEMBLY

(71) Applicant: Robert Bosch GmbH, Stuttgart (DE)

(72) Inventors: Seifeldin Tarek Mohamed Shaaban, Stuttgart (DE); Taleb Janbein, Sindelfingen (DE)

(21) Appl. No.: 18/873,876

(22) PCT Filed: Apr. 25, 2023
(86) PCT No.: PCT/EP2023/060800

§ 371 Date: Dec. 11, 2024

(30) Foreign Application Priority Data
Jun. 28, 2022 (DE) 10 2022 206 508.5

(51) Int. Cl. H02M 7/483; H02M 1/00; H02M 7/537

(52) U.S. Cl. CPC H02M 7/483; H02M 1/0043; H02M 7/537

(57) ABSTRACT

The invention relates to a voltage converter assembly in an electric drive system, said voltage converter being capable of actuating a connected electric machine in one operating mode and converting an input DC voltage into an output DC voltage in another operating mode. In order to convert the input DC voltage into the output DC voltage, the phase windings of the connected electric machine can be used as inductors. In the process, the individual phase windings are energized individually on the basis of the rotor position and on the basis of a target value specification for the total current.

### BACKGROUND

The present invention relates to a voltage converter assembly, an electric drive system, and a method for operating a voltage converter assembly. In particular, the present invention relates to voltage conversion using components of an electric drive system.

Fully or at least partially electrically driven vehicles typically have an electrical drive system in which electrical energy is supplied from an energy store, such as a traction battery, by means of a power converter on an electric machine. This electrical energy store used for this purpose can be charged by an external energy source. This typically requires a separate charging circuit.

Furthermore, there is also the possibility of using components of the electric drive system for charging the electric energy store. Such an arrangement is described, for example, in the publication DE 10 2018 207 188 A1.

### SUMMARY

The present invention provides a voltage converter assembly, an electric drive system and a method for operating a voltage converter assembly having the features of the disclosure.

The following is therefore provided:

A voltage converter assembly having a voltage converter circuit and a control means. The voltage converter circuit is configured to be connected to a multi-phase electric machine. Furthermore, the voltage converter circuit is configured to convert an input DC voltage supplied at the voltage converter circuit into a predetermined output DC voltage when the electrical machine is at a standstill in a first operating mode. The control device is configured to adjust electrical currents through at least one phase winding of a multi-phase electric machine connected to the voltage converter circuit during conversion of the electrical input DC voltage into the predetermined output DC voltage. The adjustment of the electrical currents by the respective phase winding is carried out in particular using a rotor position of the electric machine.

The following is furthermore provided:

An electric drive system having a voltage converter assembly according to the present invention and a multi-phase electric machine. The electric machine is electrically coupled to the voltage converter assembly.

Finally, the following is provided:

A method for operating a voltage converter assembly. The voltage converter assembly comprises a voltage converter circuit. The voltage converter circuit is configured to be connected to a multi-phase electric machine. The method includes a step of determining a rotor position of an electric machine connected to the voltage converter circuit. Furthermore, the method includes a step of actuating the voltage converter circuit to convert an input DC voltage supplied to the voltage converter circuit into a predetermined output DC voltage. The conversion of the input DC voltage to the output DC voltage occurs in particular when the connected electric machine is stopped. In the method according to the invention, electrical currents are individually adjusted through at least one phase winding of a multi-phase electric machine connected to the voltage converter circuit during conversion of the electrical input DC voltage into the predetermined output DC voltage. The adjustment of the electrical currents is carried out in particular using the rotor position of the electric machine.

The present invention is based on the recognition that the resulting inductances of the individual phase windings of a multi-phase electric machine can vary as a function of the rotor position of the electric machine, in particular in permanently energized synchronous machines. Therefore, if components of the electric drive system are used for a voltage conversion of an input DC voltage into an output DC voltage, the electrical properties resulting from the or position-dependent inductances may also fluctuate.

It is therefore an idea of the present invention to take this realization into account and to take into account the rotor position as well as the resulting variable inductances of the phase windings in an electric machine when using components of an electric drive system for voltage conversion.

For this purpose, when using components of an electric drive system for a voltage conversion of an input DC voltage into an output DC voltage, it is provided that the electrical currents are individually adjusted through the phase windings, i.e. the stator windings of a connected electric machine. In other words, multiple phase windings in a connected electrical machine are used for the voltage conversion, so the electrical currents can be adjusted separately though the phase windings used. The adjustment of the respective currents through the individual phase windings can take place in particular taking into account the current rotor position or the resulting individual inductances of the phase windings as well as the required total current strength.

In this way, it is possible to adjust the overall system for the voltage conversion of the input DC voltage into the output DC voltage to the respective resulting inductances of the connected electric machine. In this way, the performance for voltage conversion may be optimized.

In particular, the resulting current and/or voltage ripple can be minimized by taking into account the rotor position and the resulting inductances for energizing the phase windings. This also reduces the requirements for filtering or interference suppression measures. In particular, the capacity required to compensate the specified current and/or voltage regulators may be minimized, for example. In addition, the individual energization of the phase windings according to the invention as a function of the rotor position can also minimize a torque occurring in the electric machine during the voltage conversion.

According to one embodiment, the voltage converter assembly comprises a DC voltage terminal and an alternating voltage terminal. The DC voltage input terminal is configured to be connected to an electric energy store, for example a battery. The AC voltage terminal is configured to be connected to an electric machine. Furthermore, the voltage converter circuit is configured to receive the input DC voltage between a connection point of the DC voltage terminal and a motor terminal in the first operating mode and to supply the output DC voltage between the first connection point and a second connection point of the DC voltage terminal. Thus, for example, the voltage converter circuit may be an electrical power converter configured to actuate an electric machine using the electrical energy supplied by the electric energy storage system at the DC voltage terminal, or alternatively, such an electrical power converter may charge the electrical energy store using electrical energy provided in the form of an AC voltage from the electrical machine. Such a switching regulation may be used in a further operating mode referred to herein as the first operating mode to convert the DC voltage supplied by an external DC voltage source into a DC voltage suitable for charging the electrical energy store. The electrical energy store unit is connected to the DC voltage terminal unchanged for this purpose. The input DC voltage can be provided between a connection point (preferably the negative pole) of the electrical energy store and a motor terminal. Depending on the configuration, either a phase terminal of the electric machine or a star point of the electric machine can be used as the motor terminal. In other words, the input DC voltage from the external source is provided between a phase terminal or the star point of the electric machine and a connection point of the electrical energy store or DC voltage terminal of the voltage converter circuit.

According to one embodiment, the control means of the voltage converter assembly is configured to adjust the electrical current or electrical currents through the at least one of the phase windings using a setpoint for a total current to be adjusted. The total current may refer, for example, to the electrical current at the input or output of the voltage converter assembly. Accordingly, the total current to be adjusted may be divided into one or more of the phase windings according to the rotor position. For example, with relatively low total currents, it may be necessary to allocate the current completely to one phase winding. For higher currents, however, it may be necessary to divide the total current into two or more phase windings. In particular, the rotor position or the inductances resulting from the rotor position for the individual phase windings can also be taken into account in this division.

According to one embodiment, the control means of the voltage conversion assembly is configured to determine inductance values for the phase windings of the multi-phase electric machine connected to the voltage transformer circuit. The determination of the individual inductances for the respective phase windings can be carried out in particular using the rotor position of the electric machine. Furthermore, the control means is configured to adjust the electrical currents through the phase windings of the electric machine using the determined inductance values. Thus, by determining the resulting inductance values for the phase windings of the connected electric machine, a magnitude is available that is very well suited to determining the electrical currents through the respective phase windings.

According to one embodiment, the voltage converter assembly comprises a memory device. The memory device is configured to provide data for a correlation between the rotor position of the electric machine and the electrical currents to be adjusted in the phase windings of the electric machine. In this case, the memory device may be configured to read out the data stored in the memory device and to adjust the electrical currents through the individual phase windings of a connected electrical machine using the data read out from the storage means. For example, the correlations between the rotor position and the respective electrical currents to be adjusted can be stored in the form of a so-called lookup table or in any other form. In addition to a tabular form, it is in particular also possible to provide a formulaic correlation between the rotor position and the electrical currents to be adjusted. Furthermore, more complex correlations are also possible, in which further parameters are taken into account in addition to the rotor position and the electrical currents to be adjusted. Such further parameters may include, for example, input current, output current, input voltage, output voltage, or any other operating parameters, such as temperatures, in particular rotor and/or stator temperatures, or the like.

According to one embodiment, the control means is configured to adjust a phase shift between the electrical currents through at least two phase windings of the multi-phase electric machine connected to the voltage converter circuit. The adjustment can be carried out using a rotor position of the electric machine and, if necessary, the required charging current. In particular, a phase shift between alternating electrical voltages applied to the individual rotor phases can be adjusted depending on the rotor position and/or the resulting individual inductances of the individual phase windings. For example, the rising or falling edges of the individual pulses or the pulse centers can also be adjusted as a function of the rotor position in the case of pulse width modulated control for applying electrical currents to the individual phase windings.

According to one embodiment, the control means of the voltage converter assembly is configured to receive a signal from a rotor angle sensor of the electric machine. In this case, the electrical currents may be adjusted by the phase windings of the electrical machine using the received signal from the rotor angle sensor. In other words, the determination of the respective rotor position is made by receiving a corresponding sensor signal from a rotor angle sensor coupled to the electric machine.

According to a further embodiment, the control means of the voltage converter assembly is configured to calculate or estimate the rotor position of the multi-phase electric machine connected to the voltage converter circuit. Accordingly, the electrical currents through the phase windings of the electrical machine may be adjusted using the rotor position determined in this way. In this case, the rotor position of the connected electric machine may be calculated or estimated based on a mathematical model or the like.

According to one embodiment, the control means of the voltage converter assembly is configured to further adjust the electrical currents through the phase windings of the electric machine using further operating parameters of the voltage converter assembly and/or the multi-phase electric machine connected to the voltage converter circuit. An optimal operating point can thereby be determined, which, in addition to the rotor position of a connected electrical machine and the resulting individual inductances in the phase windings, also takes into account other operating parameters for optimum operation. Such further operating parameters may include, for example, voltage/current level of input and/or output voltage, operating temperatures, in particular calculated, estimated or measured temperatures in or at the connected electric machine, in particular at the stator and/or rotor of the electric machine, as well as any other suitable operating parameters.

According to one embodiment, the voltage converter assembly is further configured to provide an electric voltage for actuating the multi-phase electric machine in a second operating mode. In other words, the voltage converter assembly according to the invention is suitable for controlling a connected electric machine. In addition, the voltage converter assembly is suitable for using the inductances of the phase windings of this connected electric machine for a voltage conversion of an input DC voltage into an output DC voltage. Thus, for example, an electric drive system may be realized that draws electrical energy from a connected energy store for operation of the electric machine. In so doing, this electrical energy store can be charged using components of the driving circuit of the electric machine as well as the inductances of the phase windings of the connected electric machine. This allows multiple use of the existing components.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic diagram of a circuit arrangement for an electric drive system, as it may be based on an embodiment of the present invention;

FIG. 2: a schematic diagram of an alternative circuit arrangement for an electric drive system as it may be based on an embodiment of the present invention;

FIG. 3: a schematic view of a block diagram of an electric drive system with a voltage converter assembly according to one embodiment; and

FIG. 4 a flowchart as it underlies a method for operating a voltage converter assembly according to one embodiment.

### DETAILED DESCRIPTION

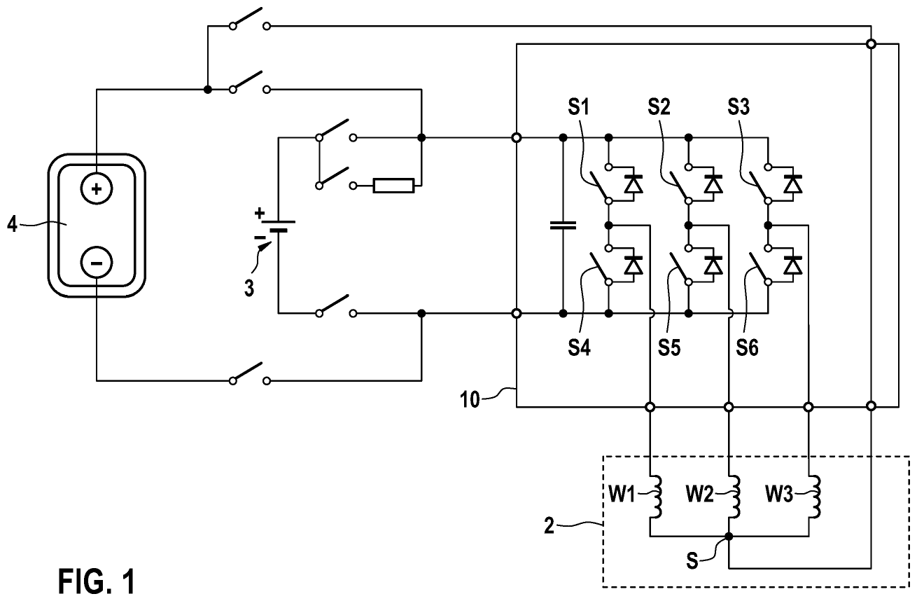

FIG. 1 shows a schematic view of a circuit arrangement for an electric drive system. The electric drive system includes a voltage converter circuit 10. This voltage converter circuit 10 can be electrically coupled to an electrical energy store 3, for example a battery, at a DC voltage terminal. For this purpose, the DC voltage terminal may comprise, for example, two connection points at which the two poles of the electrical energy store 3 can be connected. Furthermore, the voltage converter circuit 10 may be electrically coupled to an electric machine 2 at an AC voltage terminal. The electric machine 2 may be a multi-phase electric machine with, for example, three phase windings W1, W2, W3. Accordingly, the AC voltage terminal may have a connection point for each phase winding W1, W2, W3. However, the present invention is not limited to three phase electric machines. In principle, any other multi-phase electric machines with a number of phase windings other than three can be used.

For operation of the electric drive system, the voltage converter circuit 10 may convert the voltage supplied by the electric energy store 3 into a multi-phase AC electric voltage according to a target value specification and provide it to the electric machine 2. For this purpose, the switching elements S1-S6 of the voltage converter circuit 10 can be controlled accordingly.

In a further operating mode, the voltage converter circuit 10 with the connected electric machine 2 may be used to convert an electrical voltage from an external energy source 4 into an electrical voltage suitable for charging the energy store 3. The phase windings W1, W2, W3 can be used as inductive components. For this purpose, electrical energy, in particular in the form of a DC voltage, can be supplied from the external energy source 4 between a motor terminal and a connection point of the energy store 3. Preferably, any existing switches between the external energy source 4 and the motor terminal and a connection point of the energy store 3, preferably the negative connection point or the negative pole of the energy store 3, are closed. As will be explained in more detail below, the motor connection is in particular either a connection to one of the phase windings or a connection to the star point of the phase windings.

In the embodiment shown in FIG. 1, for example, a connection of the external energy source 4 can be electrically coupled to a star point S of the electric machine 2. This circuit arrangement is also referred to as W circuit. The phase windings W1, W2, W3 can be energized by appropriate clocking of the switching elements M1-M6 of the voltage converter circuit 10. In this way, the voltage level and/or current level for charging the energy store 3 from the external energy source 4 can be adjusted.

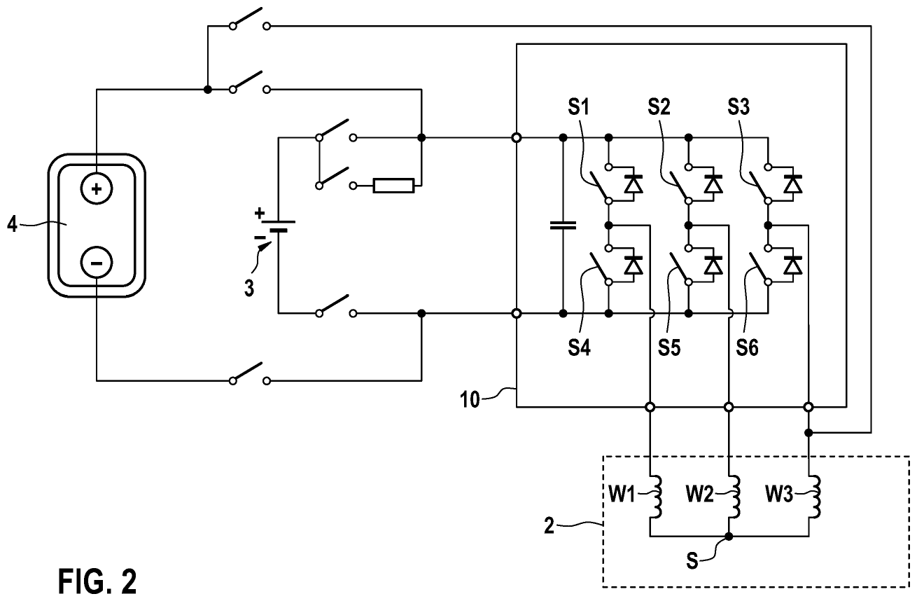

FIG. 2 shows a schematic diagram of a further circuit arrangement of an electric drive system, in which the voltage converter circuit 10 and the electric machine 2 can also be used to convert the electric voltage supplied by the external energy source 4 into a voltage suitable for charging the energy store 3. The circuit arrangement according to FIG. 2 differs from the previously described circuit arrangement in particular in that the star point S of the electric machine 2 is not connected to a terminal of the external energy source 4, but rather the terminal of a phase winding W3. Such a circuit arrangement is also referred to as a Y circuit. Preferably, any existing switches between the external energy source 4 and the motor terminal and a connection point of the energy store 3, preferably the negative connection point or the negative pole of the energy store 3, are also closed.

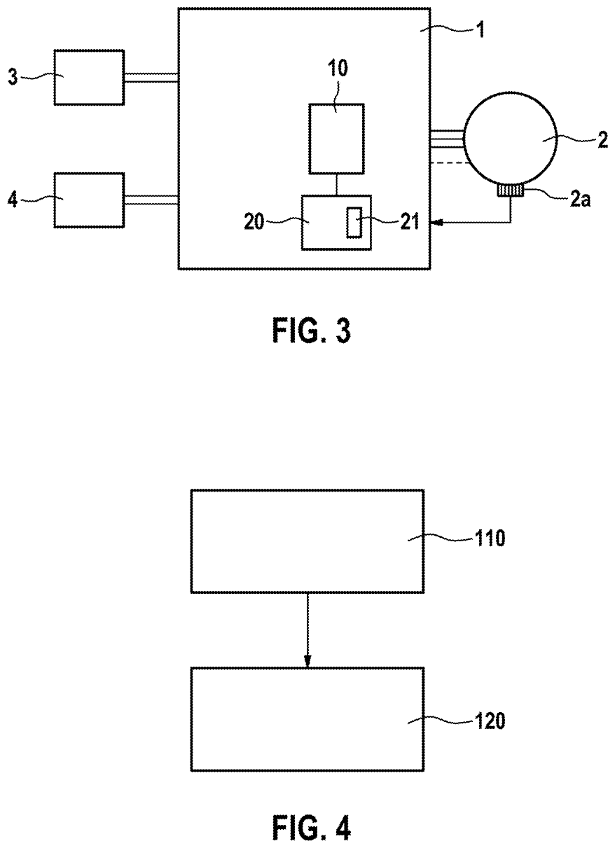

FIG. 3 shows a schematic representation of a block diagram for an electric drive system according to one embodiment. The electric drive system can comprise a voltage converter assembly 1, which is electrically connected to an electric machine 2. The voltage converter assembly 1 can comprise a voltage converter circuit 10, which converts an electrical voltage supplied by an electrical energy store 3, in particular a DC voltage, into an electrical voltage suitable for actuating the electric machine 2. In particular, this can be one of the voltage converter circuits 10 previously described in connection with FIGS. 1 and 2. Accordingly, the voltage converter assembly 1 with the voltage converter circuit 10 can also convert electrical energy from an external energy source 4 into an electrical voltage suitable for charging the energy storage 3 in a further operating mode. For this purpose, the voltage converter circuit 10, and in particular the switching elements M1-M6 of the voltage converter circuit 10, can be actuated by the corresponding control signal from the control means 20. Furthermore, the switching elements not specified in more detail in FIGS. 1 and 2 between the external energy source 4, the voltage converter circuit 10 and the electrical energy store 3 can also be opened or closed in a suitable manner depending on the operating mode.

In the operating mode for converting the input DC voltage from the external energy source 4 into an electric voltage for charging the energy store 3, the phase windings W1, W2, W3 are used as inductive components in the electric machine 2. The inductances resulting from the respective phase winding W1, W2, W3 of the electric machine 2 can vary as a function of the position of the rotor and the desired total current through the phase windings W1, W2, W3 of the electric machine 2. Therefore, the control means 20 of the voltage converter assembly 1 adjusts the control of the voltage converter circuit 10 according to the rotor position of the electric machine 2 or the resulting inductances of the phase developments W1, W2, W3. As a result, an individual energizing takes place for each phase winding W1, W2, W3 used as a function of the rotor position of the electric machine 2.

For example, the current rotor position of the rotor of the electric machine 2 can be detected by means of a rotor position sensor 2a or resolver and provided to the control means 20. Alternatively, any other methods for determining the rotor position may also be employed. For example, the rotor position can also be determined or estimated using a sensorless method.

For the actuation of the voltage converter circuit 10, a correlation between the rotor position and parameters for controlling the voltage converter circuit 10 can be stored in the control means 20, for example. For this purpose, for example, a memory device 21 can be provided in the control means 20, which stores and provides pre-determined correlations between rotor positions and control parameters. For example, these correlations may be provided in tabular form, e.g. in the form of a so-called lookup table or the like. Furthermore, any other possibilities for representing the correlation between rotor position and control of the voltage from the circuit 10 are of course also possible. In particular, correlations are also possible by means of a formula relationship, a mathematical model, or the like.

Moreover, in addition to the current rotor position, other suitable parameters may also be considered for the adjustment of the control of the voltage converter circuit 10. For example, the control may also be adjusted as a function of input voltage, input current, output voltage, output current or further operating parameters such as temperature, for example motor temperature, in particular temperatures in the phase windings or the rotor of the electric machine 2 or the like.

By adjusting the control for an individual energizing of the phase windings W1, W2, W3, it is possible to adjust both the current level and the phase shift between the voltages in the individual phase windings W1, W2, W3, which are applied to the individual phase windings W1, W2, W3. In addition, it is also possible to vary the number of phase windings W1, W2, W3 used for converting the input DC voltage into the output DC voltage as required, for example as a function of the rotor position, the desired charging current, the voltage level, or the like. For example, depending on the operating point, only a part of the available phase winding W1, W2, W3 may be energized.

The adjustment of the individual energization for the individual phase windings W1, W2, W3 using the rotor position as well as possibly further parameters can first be done at the start of the voltage conversion. Furthermore, it is also possible to dynamically adjust the energization of the individual phase winding W1, W2 or W3 during operation, i.e. during voltage conversion. In this way, properties of the system may be considered, if necessary, which change over time. If, for example, the output DC voltage is used to charge an electrical energy store 3, this output DC voltage may increase during the charging process. This may result in the required parameters for the individual energization of the phase windings W1, W2, W3 changing over time. For this purpose, it is possible to monitor any operating parameters of the voltage converter assembly 1 and, if necessary, of further components of the overall system, e.g. motor 2, for example, to record them using measurement technology or to determine them in another way, for example by means of a mathematical model, and to determine and adjust optimized parameters for the energization for the individual phase windings W1, W2, W3.

FIG. 4 shows a flowchart as it underlies a method for operating a voltage converter assembly 1 according to one embodiment. For example, the voltage converter assembly 1 may be the voltage converter assembly 1 previously described. Accordingly, all of the statements already made above also apply to the method as described below. Furthermore, the voltage converter assembly 1 described above may also comprise any components suitable for carrying out the method described below.

In a step 110, a rotor position of an electric machine 2 connected to the voltage converter circuit 10 is first determined. The voltage converter circuit 10 can then be actuated in step 120 to convert an input DC voltage supplied to the voltage converter circuit 10 into a predetermined output DC voltage. The conversion of the voltage takes place in particular when the connected electric machine 2 is stopped.

As previously described, electrical currents through at least one phase winding W1, W2, W3 of a multi-phase electric machine 2 connected to the voltage converter circuit 10 are adjusted during conversion of the electrical input DC voltage into the predetermined output DC voltage using the determined rotor position of the electric machine 2.

In summary, the invention relates to a voltage converter assembly in an electric drive system, said voltage converter being capable of actuating a connected electric machine in one operating mode and converting an input DC voltage into an output DC voltage in another operating mode. In order to convert the input DC voltage into the output DC voltage, the phase windings of the connected electric machine can be used as inductors. In the process, the individual phase windings are energized individually on the basis of the rotor position and on the basis of a target value specification for the total current.

1. A voltage converter assembly (1) comprising:
a voltage converter circuit (10) configured to be connected to a multi-phase electric machine (2) and to convert an input DC voltage supplied at the voltage converter circuit (10) into a predetermined output DC voltage when the electrical machine (2) is at a standstill in a first operating mode; and
a control means (20) configured to adjust electrical currents through at least one phase winding (W1, W2, W3) of a multi-phase electric machine (2) connected to the voltage converter circuit (10) during conversion of the electrical input DC voltage into the predetermined output DC voltage using a rotor position of the electric machine (2).

2. The voltage converter assembly (1) according to claim 1, wherein the voltage converter circuit (10) comprises a DC voltage terminal and an AC voltage terminal,
wherein the DC voltage terminal is configured to be connected to an electrical energy store (3), and the AC voltage terminal is configured to be connected to the electrical machine (2), and
wherein the voltage converter circuit (10) is configured to receive the input DC voltage between a connection point of the DC voltage terminal and a motor terminal on the input side in the first operating mode and to supply the output DC voltage between the first connection point and a second connection point of the DC voltage terminal on the output side.

3. The voltage converter assembly (1) according to claim 1, wherein the control means (20) is configured to adjust electrical currents through the at least one phase winding (W1, W2, W3) of the multi-phase electric machine (2) connected to the voltage converter circuit (10) using a target value for a total current to be adjusted.

4. The voltage converter assembly (1) according to claim 1, wherein the control device (20) is configured to determine inductance values for the phase windings (W1, W2, W3) of the multi-phase electric machine (2) connected to the voltage converter circuit (10) using the rotor position of the electric machine (2), and to adjust the electrical currents through the phase windings (W1, W2, W3) of the electric machine (2) using the determined inductance values.

5. The voltage converter assembly (1) according to claim 1, with a storage means (21) configured to provide data for a correlation between the rotor position of an electric machine (2) and the electrical currents to be adjusted in the phase windings (W1, W2, W3) of the electric machine (2),
wherein the control means (20) is configured to read out the data stored in the memory device (21) and to adjust the electrical currents using the data read from the memory device (21).

6. The voltage converter assembly (1) according to claim 1, wherein the control means (20) is configured to phase shift between the electrical currents through at least two phase windings (W1, W2, W3) of the multi-phase electric machine (2) connected to the voltage converter circuit (10) using a rotor position of the electric machine (2).

7. The voltage converter assembly (1) according to claim 1, wherein the control means (20) is configured to receive a signal from a rotor angle sensor (2a) of the electric machine (2) and to adjust the electrical currents through the phase windings (W1, W2, W3) of the electric machine (2) using the received signal from the rotor angle sensor (2a).

8. The voltage converter assembly (1) according to claim 1, wherein the control means (20) is configured to calculate the rotor position of the multi-phase electric machine (2) connected to the voltage converter circuit (1) and to adjust the electrical currents through the phase windings (W1, W2, W3) of the electric machine (2) using the calculated rotor position.

9. The voltage converter assembly (1) according to claim 1, wherein the control means (20) is configured to further adjust the electrical currents through the phase windings (W1, W2, W3) of the electric machine (2) using further operating parameters of the voltage converter assembly (1) and/or the multi-phase electric machine (2) connected to the voltage converter circuit (10).

10. The voltage converter assembly (1) according to claim 1, wherein the voltage converter assembly (1) is further configured to provide an alternating electric voltage in a second operating mode for controlling the multi-phase electric machine (2).

11. An electrical drive system, with:
a voltage converter assembly (1) according to claim 1; and
a multi-phase electric machine (2) electrically coupled to the voltage converter assembly (1).

12. A method for operating a voltage converter assembly (1) having a voltage converter circuit (10) configured to be connected to a multi-phase electric machine (2), with the steps of:
determining (110) a rotor position of an electric machine (2) connected to the voltage converter circuit (10);
actuating (120) the voltage converter circuit (10) to convert an input DC voltage supplied to the voltage converter circuit (10) into a predetermined output DC voltage when the connected electric machine (2) is stopped,
wherein electrical currents are adjusted by at least one phase winding (W1, W2, W3) of a multi-phase electric machine (2) connected to the voltage converter circuit (10) during conversion of the electrical input DC voltage into the predetermined output DC voltage using the determined rotor position of the electric machine (2).
